(19) United States
(12) Patent Application Publication
(10) Pub. No.: US 2026/0186479 A1
(43) Pub. Date: Jul. 2, 2026

(54) ELECTRONIC DEVICE SUPPORTING PIPELINE NETWORK CONDITION DIAGNOSIS AND FAULT PREDICTION AND OPERATING METHOD THEREOF

(71) Applicant: KOREA ELECTRONICS TECHNOLOGY INSTITUTE, Seongnam-si (KR)

(72) Inventors: Kwang Ho LEE, Seongnam-si (KR); Yong Chul JUNG, Gwangju-si (KR)

(21) Appl. No.: 19/410,844

(22) Filed: Dec. 5, 2025

(30) Foreign Application Priority Data
Jan. 2, 2025 (KR) 10-2025-0000171

(51) Int. Cl. G05B 23/02; G06N 20/10

(52) U.S. Cl. CPC G05B 23/0254; G06N 20/10

(57) ABSTRACT

An electronic device may support pipeline network condition diagnosis and fault prediction. The device may receive, as input data, labeled data related to the pipeline network condition diagnosis, and perform machine learning of a support vector machine (SVM), based on a kernel matrix operation and a sequential minimal optimization (SMO) operation on time domain features and frequency domain features of the labeled data. Then the device may perform analysis on unlabeled data related to the pipeline network condition diagnosis using the SVM machine-learned based on the labeled data, and adjust a parameter of the machine-learned SVM based on analysis results of the unlabeled data.

### CROSS REFERENCE TO RELATED APPLICATION

The present application claims priority to Korean Patent Application No. KR 10-2025-0000171 filed on Jan. 2, 2025 in the Korean Intellectual Property Office, the entire contents of which are incorporated herein for all purposes by this reference.

### BACKGROUND

### Technical Field

The present disclosure relates to a support vector machine (SVM) configured to use both labeled data and unlabeled data for training for pipeline network condition diagnosis.

### Description of Related Technology

Pipeline networks include water and sewage pipelines, energy pipelines (e.g., oil and gas pipelines), etc. Such pipeline networks are critical infrastructure for maintaining and managing city life. For example, water and sewage pipelines are essential for supplying and draining water to urban residents. It is necessary to monitor and manage these pipeline networks to ensure that the substance is transported normally and in the required amount from the supply point to the destination. In this regard, recent research has focused on diagnosing the condition of a pipeline network by collecting data on the network's status and applying machine learning.

### SUMMARY

One aspect is an electronic device and a method for operating the same, which support pipeline network condition diagnosis and fault prediction. Specifically, the electronic device overcomes the limitations regarding data collection and labeling for machine learning of a semi-supervised learning based support vector machine (SVM) device, and enables fast computation speed to allow for real-time pipeline network condition diagnosis and fault prediction.

Another aspect is an electronic device that supports pipeline network condition diagnosis and fault prediction is provided. The electronic device includes a memory storing labeled data related to the pipeline network condition diagnosis and unlabeled data related to the pipeline network condition diagnosis, and a processor functionally connected to the memory.

The processor may include a time domain feature extractor that extracts time domain features from input data, a frequency domain feature extractor that extracts frequency domain features from the input data, and a support vector machine (SVM) that receives the labeled data as input data and performs machine learning based on a kernel matrix operation and a sequential minimal optimization (SMO) operation on the time domain and frequency domain features of the labeled data.

The processor may be configured to perform analysis on the unlabeled data using the SVM machine-learned based on the labeled data, and adjust a parameter of the machine-learned SVM based on analysis results of the unlabeled data.

In an embodiment, the SVM may include a kernel matrix calculator that performs the kernel matrix operation, an SMO module that performs the SMO operation, a kernel memory that stores data generated during a machine learning process, a kernel mean calculator that calculates an average of kernel matrix operation results or SMO operation results, and a label predictor that predicts a label of data used in the machine learning process, based on the kernel matrix operation results or the SMO operation results.

In an embodiment, the SVM may further include a classification module that performs classification on sensor data of a pipeline network based on the adjusted parameter.

In an embodiment, the SVM may be implemented as a single processor.

In an embodiment, the kernel matrix calculator may be configured to calculate sums of absolute differences for the time domain features and the frequency domain features, respectively, and output an exclusive-OR (XOR) result of the calculated sums of the absolute differences.

In an embodiment, the time domain feature extractor may include a mean calculator for calculating a mean value of the input data, a root mean square (RMS) calculator for calculating an RMS value of the input data, a skewness calculator for calculating a skewness value of the input data, and a peak-to-peak calculator for calculating a peak-to-peak amplitude of the input data.

In an embodiment, the memory may include a first memory region for storing the mean value, a second memory region for storing the RMS value, a third memory region for storing the skewness value, and a fourth memory region for storing the peak-to-peak amplitude value.

In an embodiment, the frequency domain feature extractor may include a fast Fourier transform (FFT) processor that calculates a Fourier transform value for the input data, and a harmonic circuit that extracts harmonics from results of the FFT processor.

In an embodiment, the memory may include a plurality of memory regions for storing a plurality of the harmonics output from the harmonic circuit.

Another aspect is an operating method of an electronic device that supports pipeline network condition diagnosis and fault prediction is provided. The method is performed by a processor of the electronic device and includes receiving, as input data, labeled data related to the pipeline network condition diagnosis, performing machine learning of a support vector machine (SVM), based on a kernel matrix operation and a sequential minimal optimization (SMO) operation on time domain features and frequency domain features of the labeled data, performing analysis on unlabeled data related to the pipeline network condition diagnosis using the SVM machine-learned based on the labeled data, and adjusting a parameter of the machine-learned SVM based on analysis results of the unlabeled data.

In an embodiment, the method may further include performing classification on sensor data of a pipeline network using the SVM with the adjusted parameter applied.

In an embodiment, performing machine learning of the SVM may include calculating sums of absolute differences for the time domain features and the frequency domain features, respectively, in relation to the kernel matrix operation, and outputting an exclusive-OR (XOR) result of the calculated sums of the absolute differences.

The present disclosure can be applied to various pipeline network inspection environments by using both labeled data and unlabeled data, thereby supporting high classification performance for pipeline network condition diagnosis and fault prediction, and improving the cost consumption associated with data labeling. In addition, the present disclosure can provide various effects.

### BRIEF DESCRIPTION OF THE DRAWINGS

FIG. 1 is a diagram illustrating an example of a configuration of an electronic device that supports pipeline network condition diagnosis and fault prediction, according to an embodiment of the present disclosure.

FIG. 2 is a diagram illustrating an example of code information related to the implementation of sequential minimal optimization (SMO), according to an embodiment of the present disclosure.

FIG. 3 is a diagram illustrating an example of a configuration of a processor and memory related to a semi-supervised learning based support vector machine (SVM), according to an embodiment of the present disclosure.

FIG. 4 is a diagram illustrating an example of a configuration of a processor and memory related to the training of a semi-supervised learning based SVM, according to an embodiment of the present disclosure.

FIG. 5 is a diagram illustrating an example of operation of a processor and memory related to the classification of a semi-supervised learning based SVM, according to an embodiment of the present disclosure.

FIG. 6 is a diagram illustrating an example of a configuration of a kernel matrix calculator, according to an embodiment of the present disclosure.

FIG. 7 is a diagram illustrating an example of a configuration of SMO, according to an embodiment of the present disclosure.

FIG. 8 is a diagram illustrating an example of an operating method of an electronic device that supports pipeline network condition diagnosis and fault prediction, according to an embodiment of the present disclosure.

FIG. 9 is a diagram illustrating an example of a classification result of a pipeline network dataset using a semi-supervised learning based SVM, according to an embodiment of the present disclosure.

### DETAILED DESCRIPTION

A support vector machine (SVM) device, which can be used to diagnose the condition of a pipeline network, maximizes the margin between classes among numerous hyperplanes capable of separating two classes, thereby achieving the best classification performance. However, typical SVM devices perform training solely on labeled data. Consequently, during the machine learning development process, the labeling of collected data is costly and time-consuming. In particular, in the case of pipeline condition diagnosis and fault prediction, there are limitations in collecting data representative of real-world conditions, and training solely on labeled data can result in reduced classification performance for actual pipeline networks.

Now, embodiments of the present disclosure will be described in detail with reference to the accompanying drawings. However, in the following description and the accompanying drawings, well known techniques may not be described or illustrated in detail to avoid obscuring the subject matter of the present disclosure. Through the drawings, the same or similar reference numerals denote corresponding features consistently.

The electronic device that supports pipeline network condition diagnosis and fault prediction, and the method for operating the same, according to embodiments of the present disclosure described hereinafter, improve the performance of the support vector machine (SVM) by utilizing unlabeled data for pipeline network condition diagnosis. While a conventional SVM performs classification after training a model using labeled data, in real-world scenarios, most of the data is unlabeled, and the process of assigning actual labels requires a significant amount of time and cost during machine learning development. Accordingly, the semi-supervised learning based SVM of the present disclosure provides a method for adjusting the hyperplane of the SVM using a limited amount of labeled data and a large amount of unlabeled data.

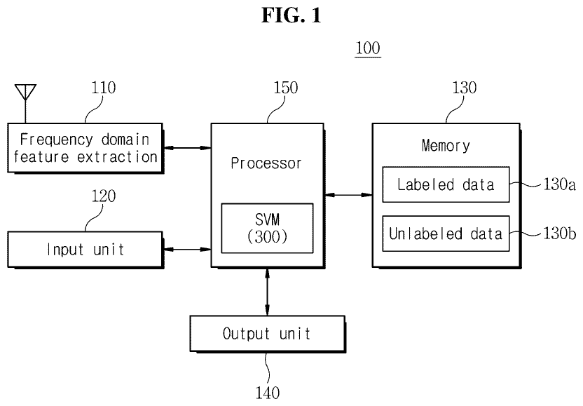

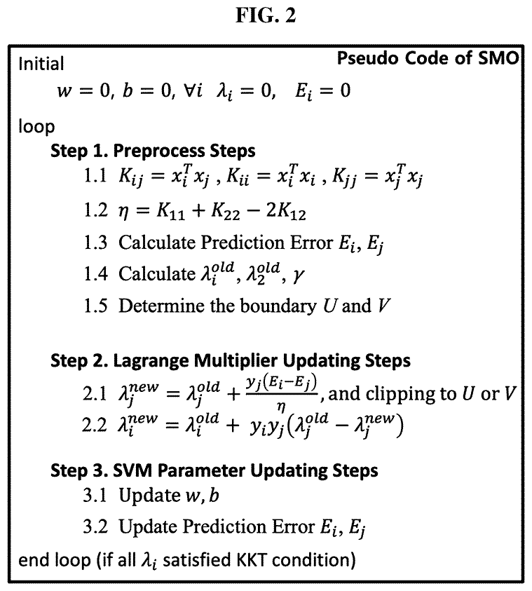

FIG. 1 is a diagram illustrating an example of a configuration of an electronic device that supports pipeline network condition diagnosis and fault prediction, according to an embodiment of the present disclosure. FIG. 2 is a diagram illustrating an example of code information related to the implementation of sequential minimal optimization (SMO), according to an embodiment of the present disclosure.

First, referring to FIG. 1, an electronic device 100 according to an embodiment may include a communication module 110, an input unit 120, a memory 130, an output unit 140, and a processor 140.

The communication module 110 may include at least one communication circuit capable of supporting the establishment of a communication channel of the electronic device 100. For example, the communication module 110 may receive sensor data of a pipeline network from an external electronic device or an external server device. The sensor data received by the communication module 110 may include, for example, labeled data (or including a label) and unlabeled data (or not including a label). Alternatively, the communication module 110 may receive labeled data from a first external server device that provides labeled data in response to the control of the processor 140, while receiving unlabeled data from a second external server device that provides unlabeled data in response to the control of the processor 140. In another example, the communication module 110 may receive unlabeled data in real time from a plurality of sensors arranged for monitoring a pipeline network. The communication module 110 may deliver the received data to the memory 130.

The input unit 120 may include at least one input mechanism that supports the input function of the electronic device 100. For example, the input unit 120 may include at least one of a keyboard, a keypad, an electronic keypad, a touchscreen, a touchpad, a mouse, a jog device, a voice input device, and a gesture input device. The input unit 120 may generate at least one of a user input signal for controlling the turn-on and turn-off of the electronic device 100, a user input signal related to the collection of pipeline network sensing data, a user input signal requesting the generation of an AI model through machine learning based on the collected sensing data, and a user input signal requesting the classification of the acquired pipeline network-related sensing data based on the generated AI model, and may deliver the generated user input signal to the processor 140.

The memory 130 may store various data or programs required for the operation of the electronic device 100. For example, the memory 130 may store labeled data 130a and unlabeled data 130b. The labeled data 130a may be data received from an external server device via at least one of the communication module 110 and the input unit 120. The labeled data 130a includes sensing data of at least one point in the pipeline network, and may include data representing a normal state of the pipeline network and data representing an abnormal state of the pipeline network at a certain ratio. For example, the labeled data 130a may include data including a label corresponding to an abnormal state of the pipeline network and data including a label corresponding to a normal state of the pipeline network. The unlabeled data 130b may include data without a label. For example, the unlabeled data 130b may include sensing data of at least one point in the pipeline network targeted for monitoring (or a pipeline network of the same type as the pipeline network to be monitored). The sensing data of the pipeline network may have different patterns depending on at least one of the pipeline material, pipeline thickness, pipeline cracks, and fluid flow conditions within the pipeline network.

The output unit 140 may output at least one kind of information related to the operation of the electronic device 100. In this regard, the output unit 140 may include at least one of a display, a speaker, a lamp, a vibration device, and a beeping device. For example, the output unit 140 may output a screen including at least one user interface related to the operation of the electronic device 100. For example, the output unit 140 may output at least one of a screen related to receiving the labeled data 130a and the unlabeled data 130b, a screen related to machine learning of a support vector machine (SVM) 300 using the received data, a screen related to adjusting parameters of the SVM 300 in the machine learning process, a screen related to generating a parameter-adjusted classification model, and a screen related to data classification based on the generated classification model.

The processor 140 may control at least one of reception, transmission, or processing of signals required for the operation of the electronic device 100, and storage or output of processing results. For example, the processor 140 may control the communication module 110 to establish a communication channel with an external server device in response to scheduled task information or a user (or administrator) request. Upon receiving the labeled data 130a and the unlabeled data 130b through the communication module 110, the processor 140 may perform parameter adjustment of the SVM 300 based on the received data and generate a classification model based on the parameter adjustment. The processor 140 may perform data classification on sensor data monitored from the target pipeline network, based on the generated classification model, and output the classification result through the output unit 140. In this regard, the processor 140 may include the SVM 300.

In an example, the processor 140 may control the SVM 300 to perform machine learning after extracting features from the labeled data 130a in both the time domain and the frequency domain. The processor 140 may analyze the unlabeled data 130b using the SVM 300, adjust the parameter values of the SVM 300 based on the analysis results, and perform data classification using the parameter-adjusted SVM. In this process, the objective function of the SVM 300 may be expressed as in Equation 1 below.

$$min \frac{{‖ w ‖}_{2}^{2}}{2} , s . t . {y}_{i} ( {w}^{T} {x}_{i} + b ) \geq 1 , i = 1 , 2 , … , n - 1 , n \qquad Equation 1$$

In Equation 1, ‘w’ is the weight value of the hyperplane, ‘x’ is the input data, ‘b’ is the bias value, and ‘y’ is the label value. The objective function of the SVM 300 is to find the maximum or minimum value for the constrained problem. In this case, when the constraint is defined as g(x)=C and the objective function is defined as f(x,y)=k, the maximum or minimum value of f(x,y)=k is satisfied when g(x,y)=C and the two functions are tangent. Therefore, if it is expressed as a Lagrange function to solve the maximization or minimization problem under the given constraint, it can be expressed as in Equation 2 below.

$$L ( w , b , λ ) = \frac{1}{2} {‖ w ‖}_{2}^{2} - \sum {λ}_{i} ( {y}_{i} ( {w}^{T} {x}_{i} + b ) - 1 ) \qquad Equation 2$$

In order to find the optimal solution in Equation 2 above, partial differentiation is performed with respect to ‘w’ and ‘b’, and then it can be expressed in the dual form as shown in Equation 3 below.

$${max}_{λ} Q ( λ ) = {\sum }_{i = 1}^{n} {λ}_{i} - \frac{1}{2} {\sum }_{i = 1}^{n} {\sum }_{j = 1}^{n} {λ}_{i} {λ}_{j} {y}_{i} {y}_{i} K ( {x}_{i} , {x}_{j} ) , \qquad Equation 3$$

$$s . t . 0 \leq {λ}_{i} \leq C , for ∀ i {\sum }_{i = 1}^{n} {λ}_{i} {y}_{j} = 0$$

Equation 3 above is equivalent to a quadratic programming problem, and methods for solving quadratic programming include a sequential minimal optimization (SMO) method, a decomposition method, a conjugate method, etc., and the present disclosure proposes a quadratic programming solution using SMO. Although the SMO has a disadvantage in that the optimization result is an approximation rather than an optimal solution, it is applied to the quadratic programming solution of the present disclosure due to its characteristics of being fast and applicable to large amounts of data compared to other techniques. Referring to FIG. 2, the pseudo-code for SMO may be set to initialize with w=0, b=0, ∀iλᵢ=0, and Eᵢ=0, and to perform a three-step loop until all λᵢ satisfy the Karush-Kuhn-Tucker (KKT) conditions. The three steps may include preprocess steps, Lagrange multiplier updating steps, and SVM parameter updating steps.

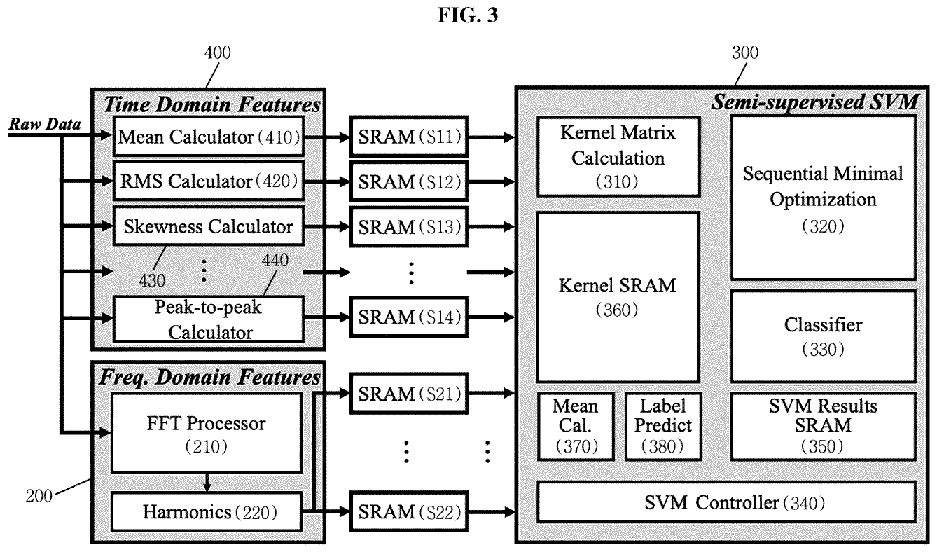

FIG. 3 is a diagram illustrating an example of a configuration of a processor and memory related to a semi-supervised learning based SVM, according to an embodiment of the present disclosure.

Referring to FIG. 3, the processor 140 may include a time domain feature extractor 400, a frequency domain feature extractor 200, a plurality of memory regions S11, S12, S13, S14, S21, and S22, and an SVM 300 (or a semi-supervised SVM).

The time domain feature extractor 400 may extract features of time-varying signals from input data (i.e., raw data). In this regard, the time domain feature extractor 400 may extract, from the input data, at least one value of mean, root mean square (RMS), skewness, trimmed mean, median, mode, minimum, maximum, variance, standard deviation, absolute deviation, and peak-to-peak amplitude. According to an embodiment, the time domain feature extractor 400 may include at least one of a mean calculator 410 for extracting the mean value of input data, an RMS calculator 420 for extracting the RMS value of input data, a skewness calculator 430 for detecting the skewness of input data, and a peak-to-peak calculator 440 for detecting the peak-to-peak amplitude (or interval between peak values) of input data.

The frequency domain feature extractor 200 may extract the features of signals distributed within a given frequency band in the frequency range with respect to input data (i.e., raw data, data sensed regarding the pipeline network, or the labeled data 130a and the unlabeled data 130b related to the pipeline network). For example, the frequency domain feature extractor 200 may include a fast Fourier transform (FFT) processor 210 that increases computational efficiency by utilizing the periodicity of trigonometric functions while performing calculations by discretizing the Fourier transform, and a harmonics 220 (or harmonic circuit) that partially differentiates the processing result of the FFT processor 210. The FFT processor 210 may decompose the input data into a sum of periodic functions having various frequencies and then transmit it to the harmonics 220 which extracts harmonics.

The plurality of memory regions S11, S12, S13, S14, S21, and S22 may include memory regions for storing values extracted from the time domain feature extractor 400, for example, a first memory region S11 for storing an average value, a second memory region S12 for storing an RMS value, a third memory region S13 for storing a skewness value, and a fourth memory region S14 for storing a peak-to-peak amplitude value. In addition, the plurality of memory regions S11, S12, S13, S14, S21, and S22 may include a fifth memory region S21 and a sixth memory region S22 for storing harmonic values output from the harmonics 220.

The SVM 300 may include a kernel matrix calculator 310, a kernel memory 360, a kernel mean calculator 370, a label predictor 380 (or a label prediction circuit), a sequential minimal optimization module 320 (hereinafter referred to as SMO) (or an SMO circuit), a classification module 330 (or a classification circuit, or a classifier), an SVM result storage 350, and an SVM controller 340. Here, the SVM 300 may support a learning (or training) function with a single processor, which includes the kernel matrix calculator 310, the kernel memory 360, the kernel mean calculator 370, the label predictor 380, and the SMO 320. In addition, the SVM 300 may support a single-processor classification mode, which includes the kernel matrix calculator 310, the kernel memory 360, and the classification module 330.

The kernel memory 360 may receive the extracted time domain features (e.g., at least one value of mean, RMS, skewness, and peak-to-peak amplitude of input or raw data) from the time domain feature extractor 400 and store them. In addition, the kernel memory 360 may receive the extracted frequency domain features (e.g., harmonic values) from the frequency domain feature extractor 200 and store them. The kernel memory 360 may transfer the stored time domain features and frequency domain features to the kernel matrix calculator 310. In addition, the kernel memory 360 may temporarily or semi-permanently store the calculation result value of the kernel matrix calculator 310.

The kernel matrix calculator 310 may perform matrix operations on the feature values stored in the kernel memory 360. For example, the kernel matrix calculator 310 may calculate the sum of absolute differences (SAD) between the time domain features and the harmonic values stored in the kernel memory 360. In particular, the kernel matrix calculator 310 may be implemented with a structure that does not require a multiplier.

The kernel mean calculator 370 may calculate the mean of the results of the semi-supervised learning based SVM 300. The kernel mean value calculated by the kernel mean calculator 370 may be temporarily or semi-permanently stored in the kernel memory 360.

The label predictor 380 may perform label prediction on data subject to machine learning by the SVM 300. For the labeled data 130a, the label predictor 380 may predict, for example, whether the result of the current kernel matrix operation and SMO operation corresponds to a label belonging to data indicating a normal state of the pipeline network or a label belonging to data indicating an abnormal state of the pipeline network. The label predictor 380 may support parameter adjustment of the SVM 300 in the machine learning process by comparing the predicted result with the label included in the labeled data 130a.

The SMO 320 relates to performing sequential minimal optimization and is a hardware implementation of the quadratic programming described above. The SMO 320 is a tool for training the SVM 300.

The classification module 330 may perform classification on the unlabeled data 130b. Alternatively, after training the SVM 300 is complete, classification may be performed on sensing data of the target pipeline network.

The SVM result storage 350 may store the results classified by the classification module 330 after training the semi-supervised learning based SVM 300 is complete. The results stored in the SVM result storage 350 may be output to an external device (e.g., the output unit 140) under the control of the SVM controller 340.

The SVM controller 340 may control the operations of respective components of the semi-supervised learning SVM 300 implemented in hardware form. For example, the SVM controller 340 may control the timing for reading the time domain features and harmonic values stored in the plurality of memory regions S11, S12, S13, S14, S21, and S22, and control to store the read time domain features and harmonic values in the kernel memory 360. Upon storing the time domain features and harmonic values for new input data (raw data) in the kernel memory 360, the SVM controller 340 may control the operation of the kernel matrix calculator 310 and the optimization of the SMO 320. After supervised learning using the labeled data 130a is performed, the SVM controller 340 may control adjusting the parameters of the SVM 300 while performing analysis on the unlabeled data 130b, and control performing data classification using the SVM 300 with parameters adjusted.

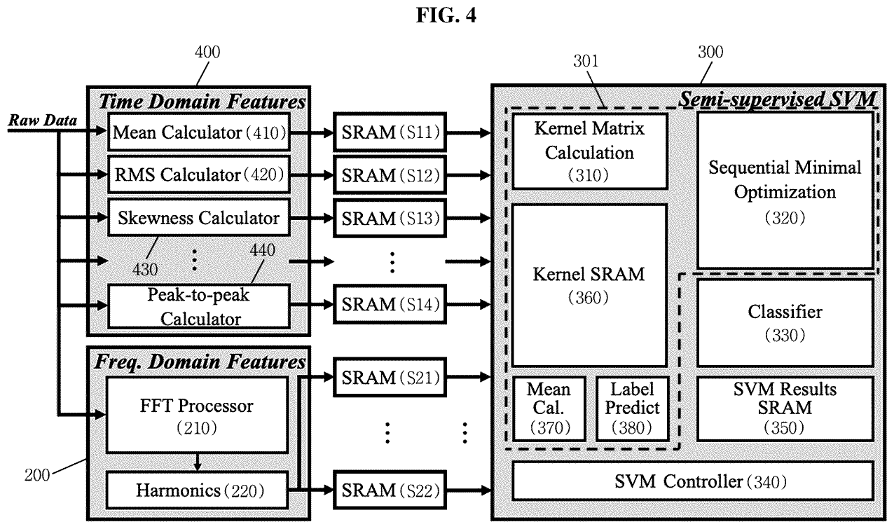

FIG. 4 is a diagram illustrating an example of a configuration of a processor and memory related to the training of a semi-supervised learning based SVM, according to an embodiment of the present disclosure.

Referring to FIG. 4, the SVM controller 340 included in the processor 140 of the electronic device 100 may perform training of the SVM 300 based on the labeled data 130a. In this regard, for example, the SVM controller 340 may control to perform training on the labeled data 130a based on a single processor 301 for training that includes the kernel memory 360, the kernel matrix calculator 310, the kernel mean calculator 370, the label predictor 380, and the SMO 320. For example, the SVM controller 340 may control to input the labeled data 130a stored in the memory 130 of the electronic device 100 as input data (raw data) of the time domain feature extractor 400 and the frequency domain feature extractor 200. The SVM controller 340 may read the time domain features extracted by the time domain feature extractor 400 and the frequency domain features extracted by the frequency domain feature extractor 200 from the plurality of memory regions S11, S12, S13, S14, S21, and S22, store them in the kernel memory 360, and perform learning on the labeled data 130a by performing operations on the time domain and frequency domain features using the kernel matrix calculator 310 and the SMO 320. In this process, the SVM controller 340 may perform normal and abnormal predictions for the labels based on the output of the kernel mean calculator 370 and/or the output of the SMO 320, and perform learning that verifies the decision boundary and performs parameter adjustment by comparing the prediction results with the labels included in the labeled data 130a.

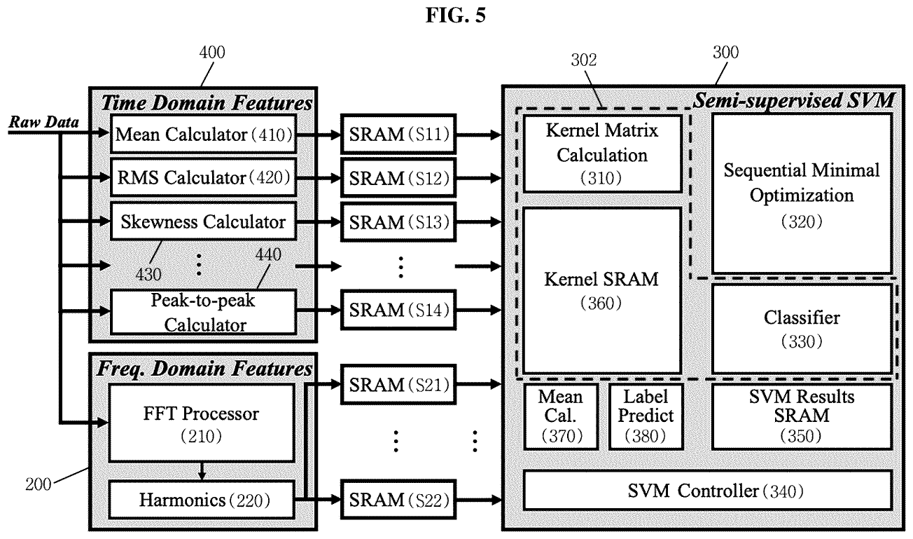

FIG. 5 is a diagram illustrating an example of operation of a processor and memory related to the classification of a semi-supervised learning based SVM, according to an embodiment of the present disclosure.

Referring to FIG. 5, the SVM controller 340 included in the processor 140 of the electronic device 100 may perform analysis on the unlabeled data 130b. In this regard, for example, the SVM controller 340 may control to perform analysis on the unlabeled data 130b based on a single processor 302 for classification that includes the kernel memory 360, the kernel matrix calculator 310, and the classification module 330. For example, the SVM controller 340 may control to input the unlabeled data 130b stored in the memory 130 of the electronic device 100 as input data (raw data) of the time domain feature extractor 400 and the frequency domain feature extractor 200. The SVM controller 340 may read the time domain features for the unlabeled data 130b extracted by the time domain feature extractor 400 and the frequency domain features for the unlabeled data 130b extracted by the frequency domain feature extractor 200 from the plurality of memory regions S11, S12, S13, S14, S21, and S22, store them in the kernel memory 360, and perform classification on the unlabeled data 130b by performing operations on the time domain and frequency domain features using the kernel matrix calculator 310 and the classification module 330.

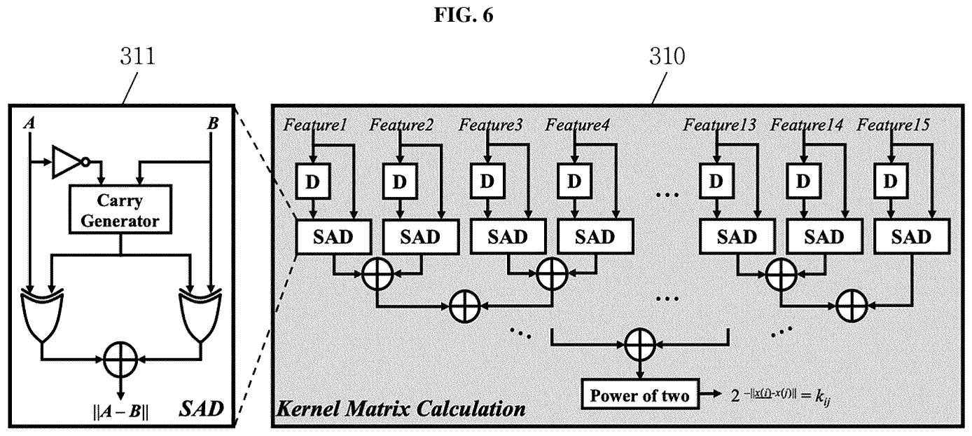

FIG. 6 is a diagram illustrating an example of a configuration of a kernel matrix calculator, according to an embodiment of the present disclosure.

Referring to FIG. 6, since the computational load of the kernel matrix calculator 310 and the computational load of the SMO 320 account for the largest portion in the case of the semi-supervised learning based SVM 300, the processor 140 is implemented so as not to include a separate multiplier for the kernel matrix calculator 310, and also the computational complexity is reduced by using a hardware friendly kernel with diagonal components of 1. For example, the kernel matrix calculator 310 may include a delay function (D) that receives the feature N (Nis 1 to 15), and the N^{th} SAD 311 that receives the output of the delay function (D) and the feature N. The SADs 311 included in the kernel matrix calculator 310 may be arranged as many as the number of features. The SADs 311 may respectively receive features and delayed values of the features (e.g., the same feature of the previous input data), and output the sum of the absolute differences for the received values. The result of the exclusive OR of the sums of the absolute differences between the previous features and the current features of a plurality of features (e.g., feature 1 to feature 15) may be output as the output of the kernel matrix calculator.

The SAD 311 is a circuit designed to output the sum of the absolute differences. Specifically, as illustrated, the SAD 311 may be designed to output the exclusive OR of: (1) the exclusive OR between the value of input A and the carry generator output value of both the value of input B and the NOT value of input A, and (2) the exclusive OR between the value of input B and the carry generator output value.

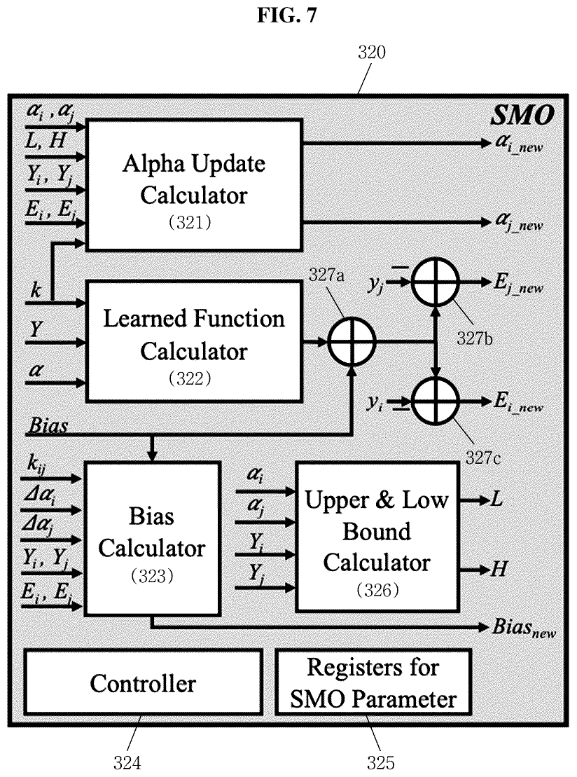

FIG. 7 is a diagram illustrating an example of a configuration of SMO, according to an embodiment of the present disclosure.

Referring to FIG. 7, the SMO may include an alpha update calculator 321 for calculating alpha values, a bias calculator 323 for calculating bias, and an upper and lower bound calculator 326 for calculating the boundary of parameters of the SVM 300. Additionally, the SMO 320 may include an SMO controller 324 for controlling the operations of the above components, an SMO parameter storage 325, and exclusive OR gates 327a, 327b, and 327c.

The alpha update calculator 321 may receive αᵢ, αⱼ, L, H, Yᵢ, Yⱼ, Eᵢ, Eⱼ, k, and k values as inputs, and output updated α_{i_new} and α_{j_new}. Here, at and a; represent the previous i^{th} and j^{th} alpha values, L represents the lower boundary value among the boundary values, and H represents the upper boundary value among the boundary values. Yᵢ and Yⱼ represent the constraint function values applied to the i^{th} and j^{th} positions for the label y, Eᵢ and Eⱼ represent the i^{th} and j^{th} error values, and k represents the kernel value.

The bias calculator 323 may receive the previous bias value (Bias), the difference (Δαⱼ, Δαⱼ) between the i^{th} and j^{th} alpha values, Yᵢ, Yⱼ, Eᵢ, and Eⱼ as inputs, and output Bias_{new} as output. The bias is the distance to the origin of the hyperplane solution.

The upper and lower bound calculator 326 may receive αᵢ, αⱼ, Yᵢ, and Yⱼ as inputs, and output the upper boundary value H and the lower boundary value L.

The learning function calculator 322 may receive k, Y, and α, and transmit the resulting value to the first SMO exclusive-OR gate 327a. The k value is a kernel value and may include the output of the kernel matrix calculator 310. The Y value is a constraint function value for the label y, and α may include a trade-off value between the initial error and the margin.

The first SMO exclusive-OR gate 327a may calculate the exclusive OR between the output from the learning function calculator 322 and the previous bias value, and transmit the result to each of the second SMO exclusive-OR gate 327b and the third SMO exclusive-OR gate 327c. The second SMO exclusive OR gate 327b may output Eⱼ_new corresponding to the exclusive OR between the j^{th} label value (yᵢ) and the output value of the first SMO exclusive-OR gate 327a. The third SMO exclusive-OR gate 327c may output Eᵢ_new corresponding to the exclusive OR between the i^{th} label value (γᵢ) and the output value of the first SMO exclusive-OR gate 327a.

The SMO parameter storage 325 may store various data generated during the operation of the SMO 320. For example, the SMO parameter storage 325 may temporarily or semi-permanently store parameters (e.g., previous alpha values (αᵢ, αⱼ), lower boundary value L, upper boundary value H, constraint function values (Yᵢ, Yⱼ) for label y, error values (Eᵢ, Eⱼ), and output (k) of the kernel matrix calculator 310) input to the alpha update calculator 321. In addition, the SMO parameter storage 325 may temporarily or semi-permanently store output values (e.g., next alpha values (α_{i_new}, α_{j_new}), output (Eⱼ_new) of the second SMO exclusive-OR gate 327b, output (Eᵢ_new) of the third SMO exclusive-OR gate 327c, output (Bias_{new}) of the bias calculator 323, and output (L,H) of the upper and lower bound calculator 326) of the alpha update calculator 321.

The SMO controller 324 may control the operations of the above-described alpha update calculator 321, learning function calculator 322, bias calculator 323, and upper and lower bound calculator 326, and the transmission of parameters supplied to such components, and may store and manage the outputs of the alpha update calculator 321, learning function calculator 322, bias calculator 323, and upper and lower bound calculator 326 in the SMO parameter storage 325. The SMO controller 324 may control machine learning for the labeled data 130a based on the control of the above-described alpha update calculator 321, learning function calculator 322, bias calculator 323, and upper and lower bound calculator 326.

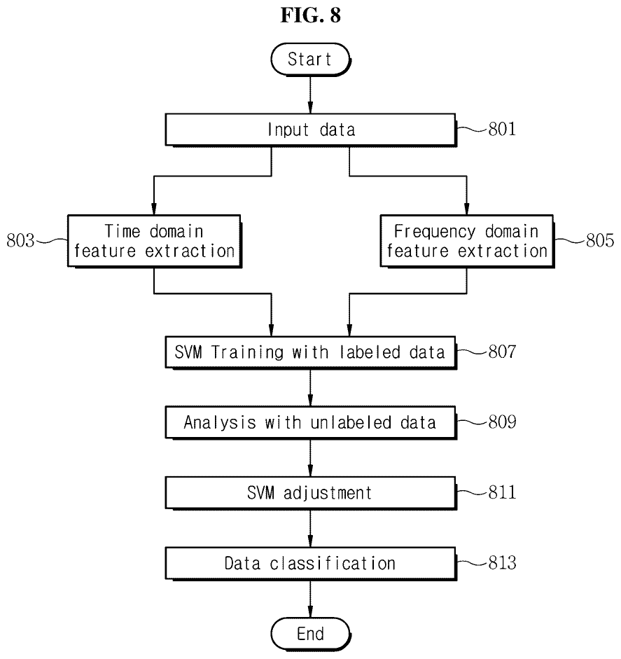

FIG. 8 is a diagram illustrating an example of an operating method of an electronic device that supports pipeline network condition diagnosis and fault prediction, according to an embodiment of the present disclosure.

Referring to FIG. 8, in the operating method of the electronic device that supports pipeline network condition diagnosis and fault prediction according to an embodiment of the present disclosure, the processor 140 of the electronic device 100 may receive input data (raw data) in step 801. The input data (raw data) may be, for example, data stored in the memory 130 of the electronic device 100 and may include the labeled data 130a.

In step 803, the processor 140 of the electronic device 100 may extract time domain features for the labeled data 130a. In this regard, the processor 140 may transmit the input data (raw data) corresponding to the labeled data 130a to the time domain feature extractor 400. In the time domain feature extraction process, the processor 140 may extract time domain features for the input data (raw data), for example, at least one value of mean, root mean square (RMS), skewness, and peak-to-peak amplitude of the input data. The processor 140 may store the extracted time domain features in the plurality of memory regions S11, S12, S13, S14, S21, and S22.

In step 805, the processor 140 of the electronic device 100 may extract frequency domain features for the labeled data 130a. In this regard, the processor 140 may transmit the input data (raw data) corresponding to the labeled data 130a to the frequency domain feature extractor 200. In the frequency domain feature extraction process, the processor 140 may extract frequency domain features for the input data (raw data), for example, harmonic values. The processor 140 may store the extracted frequency domain features in the plurality of memory regions S11, S12, S13, S14, S21, and S22.

Steps 803 and 805 may be performed regardless of the chronological order. For example, step 805 may be performed after step 803, or step 803 may be performed after step 805, or steps 803 and 805 may be performed in parallel.

In step 807, the processor 140 of the electronic device 100 may perform training of the SVM 300 on the labeled data 130a. For example, the processor 140 may store and manage the time domain features and the frequency domain features using the kernel memory 360 and perform kernel matrix operations on the features using the kernel matrix calculator 310. The output of the kernel matrix calculator 310 is delivered to the SMO 320, which may perform machine learning based on the output of the kernel matrix calculator 310.

In step 809, the processor 140 of the electronic device 100 may perform analysis on the unlabeled data 130b using the SVM 300 trained on the labeled data 130a. In step 811, the processor 140 of the electronic device 100 may adjust the parameter values of the SVM 300 based on the analysis results.

In step 813, the processor 140 of the electronic device 100 may perform data classification on the sensor data of the target pipeline network using the SVM 300 with adjusted parameters.

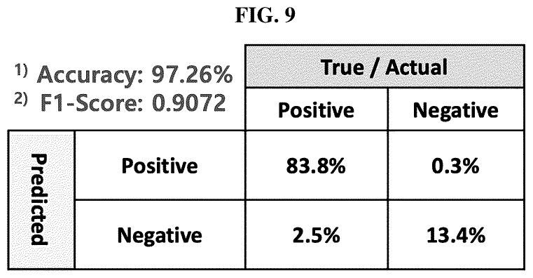

FIG. 9 is a diagram illustrating an example of a classification result of a pipeline network dataset using a semi-supervised learning based SVM, according to an embodiment of the present disclosure.

Referring to FIG. 9, the semi-supervised learning based SVM 300 of the disclosure was implemented using the ZCU104 FPGA from Xilinx. The synthesis result showed that it was synthesized with 49,585 CLB registers and 63,910 CLB LUTs, and the maximum operating frequency was confirmed to be 166 MHz. Furthermore, the classification result using the pipeline network dataset was confirmed to be 97.26%, as shown in the table in FIG. 9.

As described above, embodiments of the present disclosure provide the electronic device that utilizes the semi-supervised learning based SVM architecture as hardware for pipeline network condition diagnosis and fault prediction. In addition, the electronic device of the present disclosure offers a solution for implementing both the training and classification of the SVM into a single, dedicated hardware design.

While the present disclosure has been particularly shown and described with reference to an exemplary embodiment thereof, it will be understood by those skilled in the art that various changes in form and details may be made therein without departing from the scope of the present disclosure as defined by the appended claims.

What is claimed is:

1. An electronic device supporting pipeline network condition diagnosis and fault prediction, comprising:
a memory configured to store labeled data related to the pipeline network condition diagnosis and unlabeled data related to the pipeline network condition diagnosis; and
a processor functionally connected to the memory,
the processor comprising:
a time domain feature extractor configured to extract time domain features from input data;
a frequency domain feature extractor configured to extract frequency domain features from the input data; and
a support vector machine (SVM) configured to receive the labeled data as input data and perform machine learning based on a kernel matrix operation and a sequential minimal optimization (SMO) operation on the time domain and frequency domain features of the labeled data,
the processor configured to:
perform analysis on the unlabeled data using the SVM machine-learned based on the labeled data, and
adjust a parameter of the machine-learned SVM based on analysis results of the unlabeled data.

2. The electronic device of claim 1, wherein the SVM comprises:
a kernel matrix calculator configured to perform the kernel matrix operation;
an SMO module configured to perform the SMO operation;
a kernel memory configured to store data generated during a machine learning process;
a kernel mean calculator configured to calculate an average of kernel matrix operation results or SMO operation results; and
a label predictor configured to predict a label of data used in the machine learning process, based on the kernel matrix operation results or the SMO operation results.

3. The electronic device of claim 2, wherein the SVM further comprises:
a classification module configured to perform classification on sensor data of a pipeline network based on the adjusted parameter.

4. The electronic device of claim 3, wherein the SVM is implemented as a single processor.

5. The electronic device of claim 2, wherein the kernel matrix calculator is configured to:
calculate sums of absolute differences for the time domain features and the frequency domain features, respectively, and
output an exclusive-OR (XOR) result of the calculated sums of the absolute differences.

6. The electronic device of claim 1, wherein the time domain feature extractor comprises:
a mean calculator configured to calculate a mean value of the input data;
an root mean square (RMS) calculator configured to calculate an RMS value of the input data;
a skewness calculator configured to calculate a skewness value of the input data; and
a peak-to-peak calculator configured to calculate a peak-to-peak amplitude of the input data.

7. The electronic device of claim 6, wherein the memory comprises:
a first memory region configured to store the mean value;
a second memory region configured to store the RMS value;
a third memory region configured to store the skewness value; and
a fourth memory region configured to store the peak-to-peak amplitude value.

8. The electronic device of claim 1, wherein the frequency domain feature extractor comprises:
a fast Fourier transform (FFT) processor configured to calculate a Fourier transform value for the input data; and
a harmonic circuit configured to extract harmonics from results of the FFT processor.

9. The electronic device of claim 8, wherein the memory comprises:
a plurality of memory regions configured to store a plurality of the harmonics output from the harmonic circuit.

10. An operating method of an electronic device supporting pipeline network condition diagnosis and fault prediction, the method performed by a processor of the electronic device and comprising:
receiving, as input data, labeled data related to the pipeline network condition diagnosis;
performing machine learning of a support vector machine (SVM), based on a kernel matrix operation and a sequential minimal optimization (SMO) operation on time domain features and frequency domain features of the labeled data;
performing analysis on unlabeled data related to the pipeline network condition diagnosis using the SVM machine-learned based on the labeled data; and
adjusting a parameter of the machine-learned SVM based on analysis results of the unlabeled data.

11. The method of claim 10, further comprising:
performing classification on sensor data of a pipeline network using the SVM with the adjusted parameter applied.

12. The method of claim 10, wherein performing machine learning of the SVM includes:
calculating sums of absolute differences for the time domain features and the frequency domain features, respectively, in relation to the kernel matrix operation; and
outputting an exclusive-OR (XOR) result of the calculated sums of the absolute differences.
